(19) United States
(12) Patent Application Publication
(10) Pub. No.: US 2024/0244759 A1
(43) Pub. Date: Jul. 18, 2024

(54) Method and System for Generating Spray Patterns, Electronic Device, and Storage Medium

(71) Applicant: Vayo (Shanghai) Technology Co., Ltd., Shanghai (CN)

(72) Inventors: Yongjian QU, Shanghai (CN); Jishuo LIU, Shanghai (CN); Shengjie QIAN, Shanghai (CN); Fengshou LIU, Shanghai (CN)

(73) Assignee: Vayo (Shanghai) Technology Co., Ltd., Shanghai (CN)

(21) Appl. No.: 18/562,327

(22) PCT Filed: Apr. 11, 2022
(86) PCT No.: PCT/CN2022/086001

§ 371 Date: Dec. 27, 2023

(30) Foreign Application Priority Data
May 20, 2021 (CN) 202110554182.7

(51) Int. Cl. H05K 3/12; H05K 3/14

(52) U.S. Cl. CPC H05K 3/1208; H05K 3/14; H05K 2203/0465

(57) ABSTRACT

A method and a system for generating spray patterns, an electronic device, and a storage medium. The method includes: step 1: obtaining a first opening shape; step 2: obtaining a preset spray printing dot; step 3: obtaining a qualification ratio T according to a ratio of a total solder-paste weight Q corresponding to a total length of spray-printing line segments to a solder-paste weight Q₁ required for the first opening shape or a ratio of the total length of all the spray-printing line segments to a line length LA, wherein the spray-printing line segments are line segments finally within the first opening shape, and the qualification ratio is a weight ratio or a length ratio; and step 4: determining a relationship among the qualification ratio T, a preset maximum qualification ratio Tₘₐₓ, and a preset minimum qualification ratio Tₘᵢₙ to obtain the first spray pattern.

### CROSS REFERENCE TO RELATED APPLICATION

The present application claims the benefit of priority to Chinese Patent Application No. 2021105541827, entitled “METHOD AND SYSTEM FOR GENERATING SPRAY PATTERNS, ELECTRONIC DEVICE, AND STORAGE MEDIUMAND”, filed with CNIPA on May 20, 2021, the disclosure of which is incorporated herein by reference in its entirety for all purposes.

### FIELD OF THE INVENTION

The present disclosure generally relates to printed circuit boards, in particular, to a method and a system for generating spray patterns, an electronic device, and a storage medium.

### BACKGROUND OF THE INVENTION

In the realm of surface mount technology, one of the most pivotal steps in the production process is the application of solder paste. The quality of the electronic assembly circuit board is directly influenced by how well this process is controlled. Currently, there are two main methods for applying solder paste: stencil printing and spray printing. Spray printing of solder paste is a novel technique that allows for the application of a specific thickness and volume of solder paste onto both flat and uneven printed circuit boards. This method can also apply the optimal amount of solder paste needed for specific components, ensuring highly reliable soldering. As 3D printed circuit boards (PCBs) and Package-on-Package (POP) soldering become more prevalent, traditional stencil printed solder paste processes may fall short. Spray printing of solder paste not only overcomes the limitations of traditional stencil printing on 3D PCBs and POP, but it also enhances the precision of solder paste application.

During the product development process, changes to the PCB design are common, in which case using stencil printing can lead to increased costs and extended product development cycles due to the need for new stencils with each change. In contrast, spray printing, which applies solder paste directly onto the PCB solder pads, only requires modifications to the spray printing program, and therefore it not only reduces costs but also shortens the product development cycle.

However, a key challenge in the spray printing process is determining the trajectory, start point, end point, and volume of the spray-printing line segments quickly and accurately. This is a core technical difficulty in spray printing of solder paste.

### SUMMARY OF THE INVENTION

To resolve the foregoing problems of the related technologies, the present disclosure provides a method and a system for generating spray patterns, an electronic device, and a storage medium.

The method for generating spray patterns includes:
step 1: obtaining a first opening shape, wherein a first preset direction corresponds to a length of the first opening shape, a second preset direction corresponds to a width of the first opening shape, and the first preset direction and the second preset direction are perpendicular to each other;
step 2: obtaining a preset spray printing dot;
step 3: obtaining a qualification ratio T according to a ratio of a total solder-paste weight Q corresponding to a total length of spray-printing line segments to a solder-paste weight Q₁ required for the first opening shape or a ratio of the total length of all the spray-printing line segments to a line length LA, wherein the spray-printing line segments are line segments finally within the first opening shape, and the qualification ratio is a weight ratio or a length ratio; and
step 4: determining a relationship among the qualification ratio T, a preset maximum qualification ratio Tₘₐₓ, and a preset minimum qualification ratio Tₘᵢₙ; and obtaining a first spray pattern if Tₘᵢₙ<T<Tₘₐₓ is satisfied; or adjusting a parameter if Tₘᵢₙ<T<Tₘₐₓ is not satisfied, and obtaining a first spray pattern if Tₘᵢₙ<T<Tₘₐₓ is satisfied after the parameter is adjusted; or performing step 2 to adjust the preset spray printing dot if Tₘᵢₙ<T<Tₘₐₓ is still not satisfied after the parameter is adjusted, and performing step 3 and step 4 again according to the adjusted preset spray printing dot until Tₘᵢₙ<T<Tₘₐₓ is satisfied, to obtain a first spray pattern.

The system for generating spray patterns includes:
a first obtaining module, configured to obtain a first opening shape, wherein a first preset direction corresponds to a length of the first opening shape, a second preset direction corresponds to a width of the first opening shape, and the first preset direction and the second preset direction are perpendicular to each other;
a second obtaining module, configured to obtain a preset spray printing dot;
a qualification ratio generation module, configured to obtain a qualification ratio T according to a ratio of a total solder-paste weight Q corresponding to a total length of spray-printing line segments to a solder-paste weight Q₁ required for the first opening shape or a ratio of the total length of all the spray-printing line segments to a line length LA, wherein the spray-printing line segments are line segments finally within the first opening shape, and the qualification ratio is a weight ratio or a length ratio; and
a spray pattern generation module, configured to determine a relationship among the qualification ratio T, a preset maximum qualification ratio Tₘₐₓ, and a preset minimum qualification ratio Tₘᵢₙ; and obtain a first spray pattern if Tₘᵢₙ<T<Tₘₐₓ is satisfied; or adjust a parameter if Tₘᵢₙ<T<Tₘₐₓ is not satisfied, and obtain a first spray pattern if Tₘᵢₙ<T<Tₘₐₓ is satisfied after the parameter is adjusted; or perform step 2 to adjust the preset spray printing dot if Tₘᵢₙ<T<Tₘₐₓ is not satisfied after the parameter is adjusted, and perform step 3 and step 4 again according to an adjusted preset spray printing dot until Tₘᵢₙ<T<Tₘₐₓ is satisfied, to obtain a first spray pattern.

The electronic device includes a processor, a communication interface, a memory, and a communication bus, wherein the processor, the communication interface, and the memory communicate with each other through the communication bus; the memory is configured to store a computer program; and the processor is configured to implement, when executing the computer program, the steps of the method for generating spray patterns.

The storage medium stores a computer program, the computer program, when executed by a processor, implementing the steps of the method for generating spray patterns according to any foregoing embodiment.

Beneficial effects of the present disclosure are as follows:

In the method for generating spray patterns of the present disclosure, the qualification ratio T is determined by using the ratio of the total solder-paste weight Q corresponding to the total length of the spray-printing line segments to the solder-paste weight Q₁ required for the first opening shape or the ratio of the total length of all the spray-printing line segments to the line length LA, and the first spray pattern is determined by determining the relationship among the qualification ratio T, the preset maximum qualification ratio Tₘₐₓ, and the preset minimum qualification ratio Tₘᵢₙ. Therefore, in the method for generating spray patterns of the present disclosure, the trajectory, start point, end point, and volume of the spray-printing line segments can be quickly and accurately determined, and data thereof is directly provided to a spray printing system, which improves production speed, program quality, and operating efficiency of the spray printing program.

The following further describes the present disclosure in detail with reference to the accompanying drawings and the embodiments.

### BRIEF DESCRIPTION OF THE DRAWINGS

FIG. 1 is a schematic flowchart of a method for generating spray patterns according to an embodiment of the present disclosure.

FIG. 2 is a schematic flowchart of a method for generating spray patterns according to another embodiment of the present disclosure.

FIG. 3 is a schematic diagram illustrating 0-degree processing according to an embodiment of the present disclosure.

FIG. 4 is a schematic diagram of spray-printing line segments according to an embodiment of the present disclosure.

FIG. 5 is a schematic diagram of shortened spray-printing line segments according to an embodiment of the present disclosure.

FIG. 6 is a schematic diagram illustrating 0-degree processing according to another embodiment of the present disclosure.

FIG. 7 is a schematic diagram of shortened spray-printing line segments according to another embodiment of the present disclosure.

FIG. 8 is a schematic diagram of a second spray pattern according to an embodiment of the present disclosure.

FIG. 9 is a block diagram of a system for generating spray patterns according to an embodiment of the present disclosure.

FIG. 10 is a block diagram of an electronic device according to an embodiment of the present disclosure.

### DETAILED DESCRIPTION

The present disclosure is further described in detail below with reference to the specific embodiments, but implementations of the present disclosure are not limited thereto.

### Embodiment 1

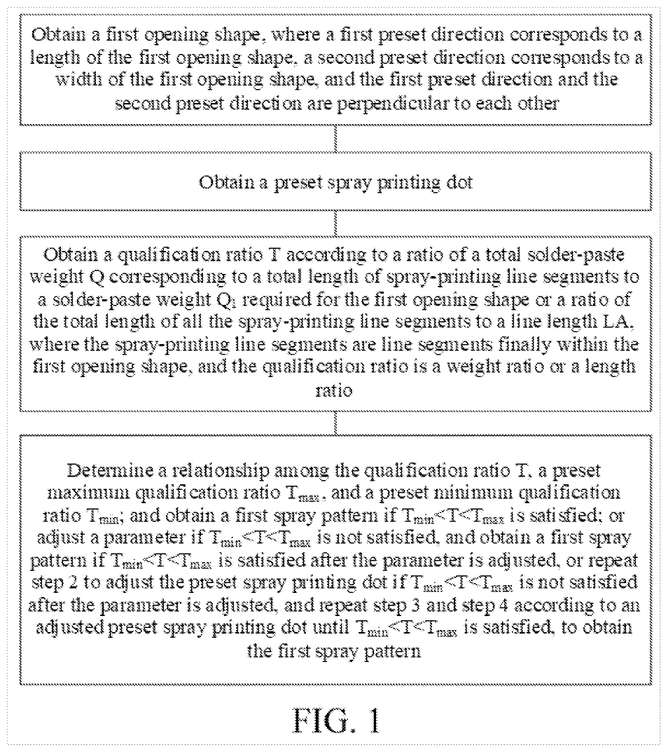

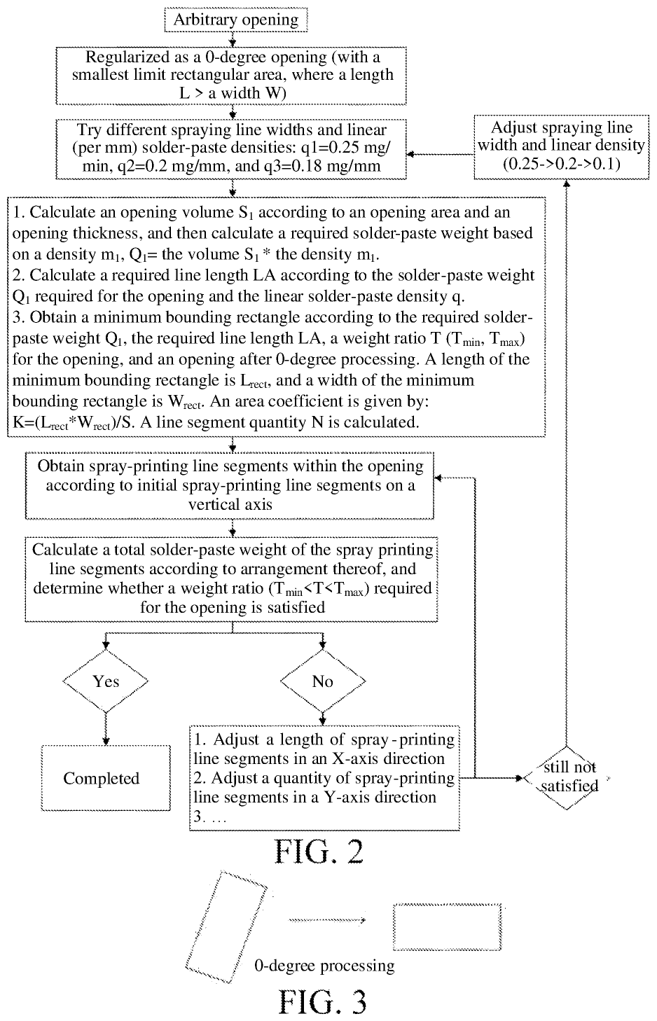

Refer to FIG. 1 and FIG. 2. FIG. 1 is a schematic flowchart of an exemplary method for generating spray patterns, and FIG. 2 is a schematic flowchart of another exemplary method for generating spray patterns. The method for generating spray patterns may include step 1 to step 4.

Step 1: obtaining a first opening shape, wherein a first preset direction corresponds to a length of the first opening shape, a second preset direction corresponds to a width of the first opening shape, and the first preset direction and the second preset direction are perpendicular to each other.

Specifically, the first opening shape is a shape obtained from a pattern file and used for spray printing of solder paste.

Preferably, the first preset direction is a horizontal direction (namely, an X-axis direction), and the second preset direction is a vertical direction (namely, a Y-axis direction).

As an example, step 1 specifically includes step 1.1 and step 1.2.

Step 1.1: obtaining an initial opening shape.

As an example, any opening shape may be first obtained according to a PCB design file or a pattern file such as a Gerber file or DXF, or an opening shape may be obtained after pattern transformation such as inward contraction, outward expansion, or corner chamfering is performed on an existing opening shape. Each of these opening shapes may be the initial opening shape, and an opening thickness H corresponding to the initial opening shape, a component name corresponding to the initial opening shape, and a pin number of the component may also be obtained by using the foregoing pattern file. The initial opening shape is generally a shape converted from a pad shape, or may be obtained from a stencil opening, or may be a pattern drawn according to component pin data.

Step 1.2: determining whether a length direction of the initial opening shape is parallel to the first preset direction; if yes, the initial opening shape is the first opening shape; and if not, rotate the initial opening shape by an angle G so that the length direction of the initial opening shape is parallel to the first preset direction to obtain the first opening shape.

Specifically, the length direction of the obtained initial opening shape may or may not be parallel to the first preset direction at first. Therefore, if the length direction of the initial opening shape is parallel to the first preset direction, there is no need to adjust the initial opening shape, and the initial opening shape is the first opening shape. If the length direction of the initial opening shape is not parallel to the first preset direction, for ease of subsequent processing, in this case, the initial opening shape is rotated by the angle G so that the length direction of the initial opening shape is parallel to the first preset direction, and an initial opening shape obtained after the rotation by the angle G is the first opening shape. As an example, the processing is also for performing 0-degree processing on the initial opening shape, namely, regularizing the initial opening shape into a 0-degree opening shape. For example, refer to FIG. 3. The figure is a schematic diagram illustrating 0-degree processing on the initial opening shape to obtain the first opening shape.

Step 2: obtaining a preset spray printing dot.

Specifically, an actual spray printing device may generate spray printing dots of different diameters. Therefore, the spray printing dots of different diameters that are usually generated by the spray printing device may be used as candidate preset spray printing dots. A soldering line width w is the same as the diameter of a corresponding preset spray printing dot, a linear solder-paste density q is solder-paste weight per millimeter with a unit of mg/mm. Therefore, when a preset spray printing dot is selected, the corresponding linear solder-paste density q may be determined. As an example, diameters of different nozzles, and soldering line widths w and linear solder-paste densities q corresponding to the different nozzles may all be recorded in a preset list. In step 2, a spray printing dot sprayed by a certain nozzle may be selected from the preset list as a preset spray printing dot. For example, diameters of different candidate preset spray printing dots may be 0.4 mm, 0.3 mm, and 0.25 mm respectively, then corresponding soldering line widths w are 0.4 mm, 0.3 mm, and 0.25 mm, and corresponding linear solder-paste densities q are 0.25 mg/mm, 0.2 mg/mm, and 0.18 mg/mm respectively. Then, when sequentially selecting each preset spray printing dot, the candidate preset spray printing dots may be traversed from 0.25 mg/mm to 0.2 mg/mm and from 0.2 mg/mm to 0.18 mg/mm.

Step 3: obtaining a qualification ratio T according to a ratio of a total solder-paste weight Q corresponding to a total length of spray-printing line segments to a solder-paste weight Q₁ required for the first opening shape or a ratio of the total length of all the spray-printing line segments to a line length LA, wherein the line length LA is a theoretical value indicating the combined length of all line segments required for forming the first opening shape in an ideal situation; wherein the spray-printing line segments are line segment finally within the first opening shape, and the qualification ratio is a weight ratio or a length ratio.

Specifically, the spray-printing line segments are line segments finally formed within the first opening shape. Therefore, when the spray-printing line segments are determined, a length of each spray-printing line segment may be determined. For example, there are N spray-printing line segments in total, and lengths thereof are respectively recorded as L₀, L₁, . . . , L_{N-1}. When the ratio of the total solder-paste weight Q corresponding to the total length of the spray-printing line segments to the solder-paste weight Q₁ required for the first opening shape or the ratio of the total length of all the spray-printing line segments to the line length LA is determined, the qualification ratio T may be obtained.

As an example, step 3 specifically includes step 3.1 to step 3.4.

Step 3.1: obtaining the line length LA according to the solder-paste weight Q₁ required for the first opening shape and the linear solder-paste density q corresponding to the preset spray printing dot.

Specifically, when the solder-paste weight Q₁ required for the first opening shape and the linear solder-paste density q are determined, a total length of the spray-printing line segments (i.e., LA) required for the first opening shape may be initially obtained.

Step 3.11: obtaining the solder-paste weight Q₁ required for the first opening shape according to an opening volume S₁ of the first opening shape and a solder-paste density m₁.

Specifically, when the opening volume S₁ of the first opening shape and the solder-paste density m₁ are determined, the solder-paste weight Q₁ required for the first opening shape is given by:

$${Q}_{1} = {S}_{1} * {m}_{1} .$$

Q₁ has a unit of mg, and m₁ has a unit of mg/mm³.

As an example, the opening volume S₁ of the first opening shape is calculated and obtained according to an area S and an opening thickness H of the first opening shape; to be specific, S₁=S*H. A top surface of the first opening shape may be, for example, a rectangle, a circle, or an irregular polygon. As an example, the first opening shape is a 3D object which is pillar-like with uniform sections, and the area of the uniform sections is the area S.

If the top surface is a rectangle, S=L*W;

if the top surface is a circle, S=π(W/2)²; and

if the top surface is an irregular polygon, for any polygon, coordinates of each vertex such as A1 (x₁, y₁), A2 (x₂, y₂), . . . , or An (Xₙ, yₙ) are obtained, and then an area of the polygon is calculated as follows:

$$S = \frac{1}{2} \sum ( {x}_{i} * {y}_{i + 1} - {x}_{i} * {y}_{i + 1} ) .$$

L is a length of the top surface of first opening shape, and W is a width of the top surface of the first opening shape.

Step 3.12: obtaining the line length LA according to a ratio of the solder-paste weight Q₁ required for the first opening shape to the linear solder-paste density q, in other words, the line length is given by:

$$LA = {Q}_{1} / q .$$

Step 3.2: obtaining a line segment quantity N of the spray-printing line segments according to an area coefficient K, the line length LA, and a length L_{rect} of a minimum bounding rectangle, wherein the minimum bounding rectangle is a smallest rectangle including the first opening shape (i.e., the top surface of the first opening shape).

Specifically, the minimum bounding rectangle is a minimum bounding rectangle of the first opening shape, namely, a smallest rectangle including the entire top surface of the first opening shape. Then, when the area coefficient K, the line length LA, and the length L_{rect} of the minimum bounding rectangle are determined, the line segment quantity N of the spray-printing line segments may be obtained.

Step 3.21: obtaining the area coefficient K according to the length L_{rect} of the minimum bounding rectangle, a width W_{rect} of the minimum bounding rectangle, and the area S of the top surface of the first opening shape.

Specifically, when the length L_{rect} of the minimum bounding rectangle, the width W_{rect} of the minimum bounding rectangle, and the area of the first opening shape are determined, the area coefficient K may be given by:

$$K = ( {L}_{rect} * {W}_{rect} ) / S .$$

Step 3.22: obtaining the line segment quantity N of the spray-printing line segments according to a line segment quantity calculation formula, the area coefficient K, the line length LA, and the length L_{rect} of the minimum bounding rectangle, wherein the line segment quantity calculation formula is as follows:

$$N = ( K * LA ) / {L}_{rect}$$

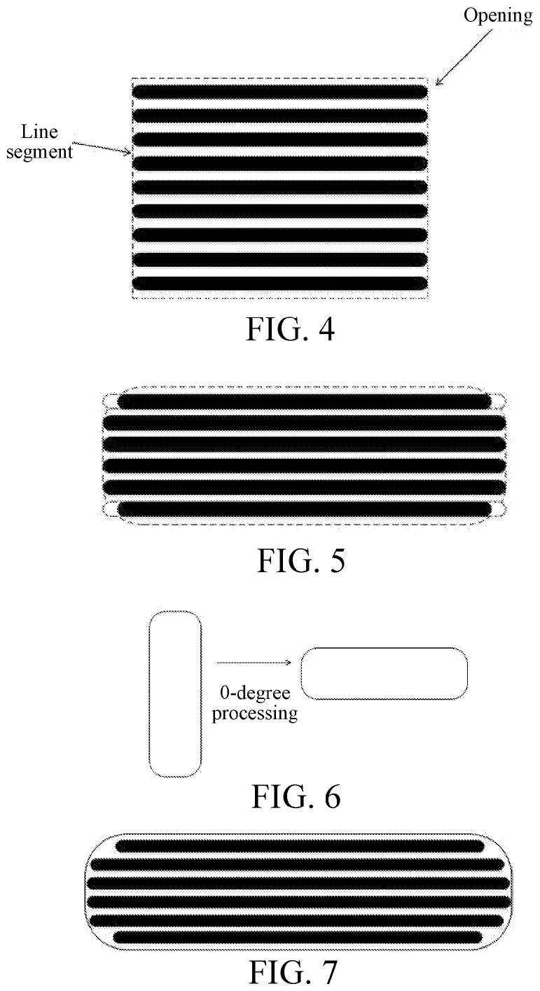

For example, refer to FIG. 4, where all the spray-printing line segments are equal in length, so that the length of each spray-printing line segment may be determined.

Step 3.3: obtaining, according to the width W_{rect} of the minimum bounding rectangle and the line segment quantity N, spray-printing line segments that are entirely within the first opening shape.

Specifically, a distance between central lines of two adjacent spray-printing line segments is first calculated and obtained according to W_{rect}/N, then with this distance, spray-printing line segments not entirely within the first opening shape are determined, and lengths of the spray-printing line segments not entirely within the first opening shape are shortened, so that the shortened spray-printing line segments are entirely within the first opening shape. For example, for the spray-printing line segments not entirely within the first opening shape, intersection points of the first opening shape and these spray-printing line segments may be first obtained, and then the spray-printing line segments are shortened inward from the intersection points by half widths of the spray-printing line segments, to obtain shortened spray-printing line segments, which are entirely within the first opening shape and obtain lengths of all the shortened spray-printing line segments, which are recorded as L₀, L₁, . . . , L_{N-1}. For example, FIG. 5 shows spray-printing line segments that are entirely within the first opening shape after adjustment.

Step 3.4: obtaining the weight ratio according to the ratio of the total solder-paste weight Q corresponding to the total length of all the spray-printing line segments to the solder-paste weight Q₁ required for the first opening shape, or obtain the length ratio according to the ratio of the total length of all the spray-printing line segments to the line length LA.

That is to say, the qualification ratio T may be a weight ratio, or may be a length ratio. The weight ratio may be determined by using the ratio of the total solder-paste weight Q corresponding to the total length of all the spray-printing line segments to the solder-paste weight Q₁ required for the first opening shape, and the length ratio may be determined by using the ratio of the total length of all the spray-printing line segments to the line length LA.

As an example, when the qualification ratio T is a length ratio, that the length ratio is obtained according to the total length of all the spray-printing line segments and the line length LA includes that the length ratio is obtained according to the ratio of the total length of all the spray-printing line segments to the line length LA, to be specific, T=[(L₀+L₁+ . . . +L_{N-1})/LA]*100.

In another example, when the qualification ratio T is a weight ratio, that the weight ratio is obtained according to the ratio of the total solder-paste weight Q corresponding to the total length of all the spray-printing line segments to the solder-paste weight Q₁ required for the first opening shape.

Specifically, the total solder-paste weight Q is obtained according to the total length of all the spray-printing line segments and the linear solder-paste density q corresponding to the preset spray printing dot; and the weight ratio is obtained according to the ratio of the total solder-paste weight Q to the ideal solder-paste weight Q₁ required for the first opening shape, to be specific, T=(Q/Q₁)*100. The total solder-paste weight Q is given by:

$$Q = ( {L}_{0} + {L}_{1} + … + {L}_{N - 1} ) * q .$$

Step 4: determining a relationship among the qualification ratio T, a preset maximum qualification ratio Tₘₐₓ, and a preset minimum qualification ratio Tₘᵢₙ, and obtaining a first spray pattern if Tₘᵢₙ<T<Tₘₐₓ is satisfied; or adjusting a parameter if Tₘᵢₙ<T<Tₘₐₓ is not satisfied, and obtaining a first spray pattern if Tₘᵢₙ<T<Tₘₐₓ is satisfied after the parameter is adjusted; or performing step 2 to adjust the preset spray printing dot if Tₘᵢₙ<T<Tₘₐₓ is still not satisfied after the parameter is adjusted, and performing step 3 and step 4 again according to an adjusted preset spray printing dot until Tₘᵢₙ<T<Tₘₐₓ is satisfied, to obtain a first spray pattern.

Specifically, in this embodiment, the final spray pattern of the preset spray printing dot is determined by determining the relationship among the qualification ratio T, the preset maximum qualification ratio Tₘₐₓ, and the preset minimum qualification ratio Tₘᵢₙ. When the qualification ratio T satisfies Tₘᵢₙ<T<Tₘₐₓ, it indicates that a spray pattern obtained after performing step 2 to step 4 is qualified, and in this case, this spray pattern is the first spray pattern. When the qualification ratio T does not satisfy Tₘᵢₙ<T<Tₘₐₓ, it indicates that the spray pattern obtained after performing step 2 to step 4 is not qualified, and in this case, the spray pattern is required to be by adjusting the parameter. If the qualification ratio T satisfies Tₘᵢₙ<T<Tₘₐₓ after adjustment, an adjusted spray pattern (namely, the first spray pattern) is obtained. If the qualification ratio T still does not satisfy that Tₘᵢₙ<T<Tₘₐₓ after adjustment, step 2 is performed to select a preset spray printing dot with another diameter, and step 3 and step 4 are repeated on the reselected preset spray printing dot until Tₘᵢₙ<T<Tₘₐₓ is satisfied, so that the first spray pattern may be obtained. The parameter may be, for example, a length of the spray-printing line segments or a quantity of the spray-printing line segments, or another relevant parameter. The preset maximum qualification ratio Tₘₐₓ and the preset minimum qualification ratio Tₘᵢₙ are both preset values. For example, the preset maximum qualification ratio Tₘₐₓ is 120, and the preset minimum qualification ratio Tₘᵢₙ is 80.

Preferably, the parameter required to be adjusted includes a length of the spray-printing line segments in an X-axis direction or a quantity of the spray-printing line segments in a Y-axis direction.

As an example, in response to that a parameter is adjusted when T≤Tₘᵢₙ, step 4 further includes the follow operations:
the quantity of the spray-printing line segments in the Y-axis direction is increased, step 3.3 is performed again, and whether Tₘᵢₙ<T<Tₘₐₓ is satisfied after the quantity of the spray-printing line segments in the Y-axis direction is increased is determined. If yes, the first spray pattern is obtained. If not and T≤Tₘᵢₙ, the quantity of the spray-printing line segments in the Y-axis direction is again increased, and step 3.3 is performed again correspondingly; if T is still less than or equal to Tₘᵢₙ after the quantity of the spray-printing line segments has been increased for several times and when the quantity of the spray-printing line segments cannot be further increased, step 2 is performed to adjust the preset spray printing dot, and step 3 and step 4 are performed again according to the adjusted preset spray printing dot until Tₘᵢₙ<T<Tₘₐₓ is satisfied, to obtain the first spray pattern; for example, the quantity of the spray-printing line segments is incremented by 1 during the above adjustment. If Tₘᵢₙ<T<Tₘₐₓ is not satisfied and T≥Tₘₐₓ, the length of the spray-printing line segments in the X-axis direction is shortened, step 3.3 is performed again, and whether Tₘᵢₙ<T<Tₘₐₓ is satisfied after the length of the spray-printing line segments in the X-axis direction is shortened is determined; if yes, the first spray pattern is obtained; and if not, step 2 is performed to adjust the preset spray printing dot, and step 3 and step 4 are performed again according to the adjusted preset spray printing dot until Tₘᵢₙ<T<Tₘₐₓ is satisfied, to obtain the first spray pattern.

It is to be noted that, the increased quantity of the spray-printing line segments in the Y-axis direction and the shortened length of the spray-printing line segments in the X-axis direction may be adjusted according to an actual requirement.

As an example, in response to that a parameter is adjusted when T≥Tₘₐₓ, step 4 includes the following two solutions:

Solution 1: the length of the spray-printing line segments in the X-axis direction is shortened, step 3.3 is performed again, and whether Tₘᵢₙ<T<Tₘₐₓ is satisfied after the length of the spray-printing line segments in the X-axis direction is shortened is determined; if yes, the first spray pattern is obtained; and if not and T≥Tₘₐₓ, the length of the spray-printing line segments in the X-axis direction is repeatedly shortened, and step 3.3 is performed again in each repetition until Tₘᵢₙ<T<Tₘₐₓ is satisfied, to obtain the first spray pattern.

Solution 2: The quantity of the spray-printing line segments in the Y-axis direction is decreased, step 3.3 is performed again, and whether Tₘᵢₙ<T<Tₘₐₓ is satisfied after the quantity of the spray-printing line segments in the Y-axis direction is decreased is determined. If yes, the first spray pattern is obtained. If not and T≥Tₘₐₓ, the quantity of the spray-printing line segments in the Y-axis direction is repeatedly decreased, and step 3.3 is performed again in each repetition; if T is still greater than or equal to Tₘₐₓ after the quantity of the spray-printing line segments is decreased for several times and when the quantity of the spray-printing line segments cannot be further decreased, step 2 is performed to adjust the preset spray printing dot, and step 3 and step 4 are performed again according to the adjusted preset spray printing dot until Tₘᵢₙ<T<Tₘₐₓ is satisfied, to obtain the first spray pattern. For example, the quantity of the spray-printing line segments is decremented by 1. If Tₘᵢₙ<T<Tₘₐₓ is not satisfied and T≤Tₘᵢₙ, the quantity of the spray-printing line segments in the Y-axis direction is increased, step 3.3 is performed again, and whether Tₘᵢₙ<T<Tₘₐₓ is satisfied after the quantity of the spray-printing line segments in the Y-axis direction is increased is determined; if yes, the first spray pattern is obtained; and if not and T≤Tₘᵢₙ, the quantity of the spray-printing line segments in the Y-axis direction is repeatedly increased, step 3.3 is performed again in each repetition, and if T is still less than or equal to Tₘᵢₙ after the quantity of the spray-printing line segments is increased for several times and when the quantity of the spray-printing line segments cannot be further increased, step 2 is performed to adjust the preset spray printing dot, and step 3 and step 4 are performed again according to the adjusted preset spray printing dot until Tₘᵢₙ<T<Tₘₐₓ is satisfied, to obtain the first spray pattern; for example, the quantity of the spray-printing line segments is incremented by 1; If not satisfied and T≥Tₘₐₓ, the length of the spray-printing line segments in the X-axis direction is shortened, step 3.3 is performed again, and whether Tₘᵢₙ<T<Tₘₐₓ is satisfied after the length of the spray-printing line segment in the X-axis direction is shortened is determined; if yes, the first spray pattern is obtained; and if not, step 2 is performed to adjust the preset spray printing dot, and step 3 and step 4 are performed again according to the adjusted preset spray printing dot until Tₘᵢₙ<T<Tₘₐₓ is satisfied, to obtain the first spray pattern.

It is to be noted that, the reduced quantity of the spray-printing line segments in the Y-axis direction and the shortened length of the spray-printing line segment in the X-axis direction may be adjusted according to an actual requirement.

The length of the spray-printing line segments in the X-axis direction is shortened each time by half a line width of the spray-printing line segments, and the length of the spray-printing line segment in the X-axis direction may also be shortened each time by a length of a spray-printing line segment, or by lengths of several spray-printing line segments in the X-axis direction.

As an example, because length directions of some exiting opening shapes are initially not parallel to the first preset direction, these opening shapes are rotated by an angle G so that their length directions are parallel to the first preset direction. Therefore, after the foregoing steps are completed, the rotated opening shapes are required to be restored to their initial positions. Therefore, after the first spray pattern is obtained, the method further includes:
reversely rotating the first spray pattern by the angle G to obtain a second spray pattern.

Finally, according to data interface content required by a spray printing system, parameters of line segments required by the system may be provided to the spray printing system. To be specific, parameters such as the trajectory, start point, end point, and volume of the spray-printing line segments, a component name to which the line segments belong, a component pin number to which the line segments belong, and a line order are obtained by using the second spray pattern.

The present disclosure provides a method for generating spray patterns, which is a solder-paste spray-printing technique. During the product development process, changes to the PCB design are common, in which case using stencil printing can lead to increased costs and extended product development cycles due to the need for new stencils with each change. In contrast, spray printing, which applies solder paste directly onto the PCB solder pads, only requires modifications to the spray printing program, and therefore it not only reduces costs but also shortens the product development cycle. By using the method for generating spray patterns of the present disclosure, the trajectory, start point, end point, and volume of the spray-printing line segments can be quickly and accurately determined, and data thereof is directly provided to a spray printing system, which improves production speed, program quality, and operating efficiency of the spray printing program.

### Embodiment 2

Based on the foregoing embodiment, this embodiment further provides a method for generating spray patterns. The method for generating spray patterns is described taking the qualification ratio T being a weight ratio as an example. The method for generating spray patterns includes the following operations.

S1: An existing opening shape may be obtained as tan initial opening shape according to a PCB design file, and inward contraction is then performed on the initial opening shape (the step is an optional step, which may or may not be performed), wherein an opening thickness H=0.2 mm, a component name corresponding to the opening shape is U1, and a corresponding component pin number is 1.

S2: As shown in FIG. 6 below, shape conversion is performed, to obtain a single opening, which is regularized as a 0-degree opening, that is, the opening is rotated by 90° clockwise around its center, a length L of the regularized 0-degree opening is larger than a width W of the regularized 0-degree opening, and a first opening shape may be obtained after shape conversion.

S3: The first opening shape has a length L of 4.183 mm, a width W of 1.895 mm, an opening thickness H of 0.2 mm, a solder-paste density m₁ of 3 mg/mm³, a line width w of 0.3 mm, a linear solder-paste density q of 0.2 mg/mm, with Tₘᵢₙ=80, and Tₘₐₓ=100.

S4: An opening area of the first opening shape is obtained according to a polygon area calculation formula:

$$S = 7.15327427110601 {mm}^{2} ;$$

and
an opening volume of the first opening shape is as follows:

$${S}_{1} = S * H = 7.15327427 \; 110601 * 0.2 = 1.4306548542212 {mm}^{3} .$$

S5: A solder-paste weight Q₁ required for the first opening shape is calculated as follows:

$${Q}_{1} = {S}_{1} * {m}_{1} = 1.4306548542212 * 3 = 4.2919 \; 645626636 mg .$$

S6: A required line length LA is calculated according to the solder-paste weight Q₁ required for the first opening shape and the linear solder-paste density q as follows:

$$LA = {Q}_{i} / q = 4.2919645626 \; 636 / 0.2 = 21.459822813318 mm .$$

S7: A minimum bounding rectangle is obtained according to the required solder-paste weight Q₁, the required line length LA, the qualification ratio T, and the first opening shape after 0-degree processing. A length of the minimum bounding rectangle is recorded as L_{rect}, and a width of the minimum bounding rectangle is recorded as W_{rect}. An area coefficient is calculated as follows: K=(L_{rect}*W_{rect})/S. A quantity N of spray-printing line segments is calculated as follows:

$$K = ( {L}_{rect} * {W}_{rect} ) / S = ( 4.183 * 1.895 ) / 7.15327427110601 = 1.1081337999324 ; and$$

$$N = ( {K}^{⋆} LA ) / {L}_{rect} = 1.1081337999324 ⋆ 21.459822813318 / 4.183 = 5.6849999999995 \approx 6 .$$

S8: A distance between two adjacent spray-printing line segments along a Y axis is initially calculated according to a ratio of the width W_{rect} of the minimum bounding rectangle to the quantity N of spray-printing line segments, and finally lengths of all spray-printing line segments that are entirely within the first opening shape are calculated. As shown in FIG. 7, the lengths are respectively recorded as L₀, L₁, L₂, L₃, L₄, and L₅. Obtained spray-printing line segment information is shown in Table 1.

TABLE 1
Spray-Printing Line Segment Information

| | | | | | | Component | Component |
|---|---|---|---|---|---|---|---|
| X1 | X2 | Y1 | Y2 | Line length | Order | name | pin number |
| −1.51143246362225 | 1.51142640792199 | −0.784719999999994 | −0.784719999999994 | 3.02285887154424 | 0 | U1 | 1 |
| −1.80355967905175 | 1.80355719775213 | −0.470831999999994 | −0.470831999999994 | 3.60711687680388 | 1 | U1 | 1 |
| −1.91559411162366 | 1.91559299214097 | −0.156943999999993 | −0.156943999999993 | 3.83118710376463 | 2 | U1 | 1 |
| −1.91579761860255 | 1.91559312379185 | 0.156944000000007 | 0.156944000000007 | 3.83139074239441 | 3 | U1 | 1 |
| −1.81681753473644 | 1.81625721818777 | 0.470832000000008 | 0.470832000000008 | 3.63307475292421 | 4 | U1 | 1 |
| −1.52497012830206 | 1.52412778310213 | 0.784720000000008 | 0.784720000000008 | 3.04909791140419 | 5 | U1 | 1 |

S9: A total solder-paste weight Q of the spray-printing line segments is calculated, and

$$Q = ( L 0 + L 1 + L 2 + L 3 + L 4 + L 5 ) * q = ( 3.02285887154424 + 3.607116876803 \; 88 + 3.83118710376463 + 3.83139074239441 + 3.63307475292421 + 3.049097911404 \; 19 ) * 0.2 = 4.194945251767 mg .$$

S10: The qualification ratio T required for the opening is calculated as follows:

$$T = ( Q / {Q}_{1} ) * 100 = ( 4.194945251767 / 4.2919645626636 ) * 100 = 97.73951276903 .$$

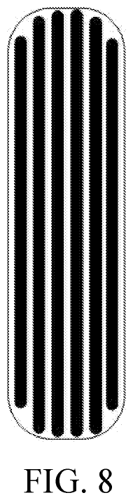

Here, Tₘᵢₙ=80<T=97.73951276903<Tₘₐₓ=100, and shape conversion is completed. Restoration processing is then performed by rotating the opening by 90° counterclockwise around its center, to obtain a final shape (i.e., the second opening shape) as shown in FIG. 8.

S11: A trajectory, start point, end point, and volume of the spray-printing line segments are outputted. The volume=(L₀+L₁+L₂+L₃+L₄+L₅)*H=4.194945251767 mm³, and the qualification ratio T=97.73951276903. A component name to which the spray-printing line segments belong, a component pin number to which the spray-printing line segments belong, and a line order are shown in Table 2.

TABLE 2
Spray-Printing Line Segment Attribute

| | | | | Line | | Component | Component |
|---|---|---|---|---|---|---|---|
| X1 | X2 | Y1 | Y2 | length | Order | name | pin number |
| 0.784719999999994 | 0.784719999999994 | −1.51143246362225 | 1.51142640792199 | 3.02285887154424 | 0 | U1 | 1 |
| 0.470831999999994 | 0.470831999999994 | −1.80355967905175 | 1.80355719775213 | 3.60711687680388 | 1 | U1 | 1 |
| 0.156943999999993 | 0.156943999999993 | −1.91559411162366 | 1.91559299214097 | 3.83118710376463 | 2 | U1 | 1 |
| −0.156944000000007 | −0.156944000000007 | −1.91579761860255 | 1.91559312379185 | 3.83139074239441 | 3 | U1 | 1 |
| −0.470832000000008 | −0.470832000000008 | −1.81681753473644 | 1.81625721818777 | 3.63307475292421 | 4 | U1 | 1 |
| −0.784720000000008 | −0.784720000000008 | −1.52497012830206 | 1.52412778310213 | 3.04909791140419 | 5 | U1 | 1 |

### Embodiment 3

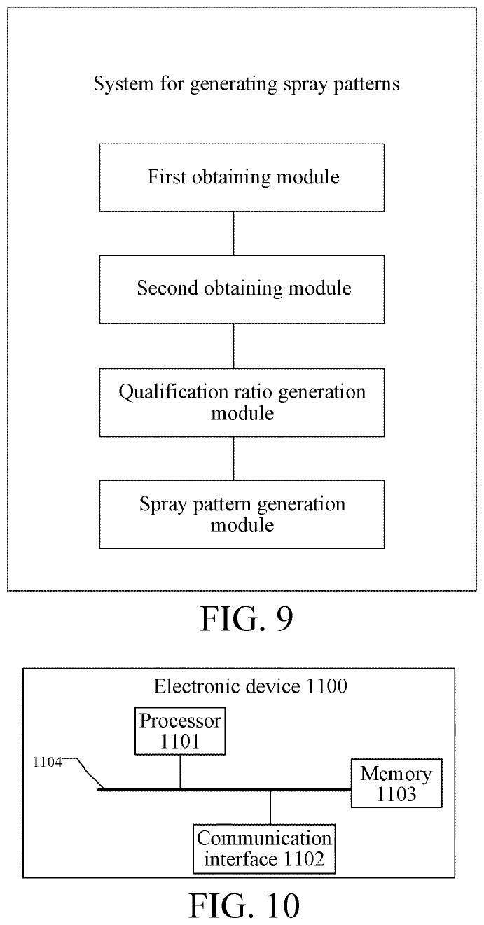

Refer to FIG. 9. FIG. 9 is a block diagram of a system for generating spray patterns according to an embodiment of the present disclosure. The system for generating spray patterns includes:
a first obtaining module, configured to obtain a first opening shape, wherein a first preset direction corresponds to a length of the first opening shape, a second preset direction corresponds to a width of the first opening shape, and the first preset direction and the second preset direction are perpendicular to each other;
a second obtaining module, configured to obtain a preset spray printing dot;
a qualification ratio generation module, configured to obtain a qualification ratio T according to a ratio of a total solder-paste weight Q corresponding to a total length of spray-printing line segments to a solder-paste weight Q₁ required for the first opening shape or a ratio of the total length of all the spray-printing line segments to a line length LA, wherein the spray-printing line segments are line segments finally within the first opening shape, and the qualification ratio is a weight ratio or a length ratio; and
a spray pattern generation module, configured to determine a relationship among the qualification ratio T, a preset maximum qualification ratio Tₘₐₓ, and a preset minimum qualification ratio Tₘᵢₙ; and obtain a first spray pattern if Tₘᵢₙ<T<Tₘₐₓ is satisfied; or adjust a parameter if Tₘᵢₙ<T<Tₘₐₓ is not satisfied, and obtain a first spray pattern if Tₘᵢₙ<T<Tₘₐₓ is satisfied after the parameter is adjusted; or perform step 2 to adjust the preset spray printing dot if Tₘᵢₙ<T<Tₘₐₓ is still not satisfied after the parameter is adjusted, and perform step 3 and step 4 again according to the adjusted preset spray printing dot until Tₘᵢₙ<T<Tₘₐₓ is satisfied, to obtain a first spray pattern.

The system for generating spray patterns provided in this embodiment may perform the foregoing method embodiments, and their implementation principles and technical effects are similar.

### Embodiment 4

Refer to FIG. 10. FIG. 10 is a block diagram of an electronic device according to this embodiment. An electronic device 1100 includes: a processor 1101, a communication interface 1102, a memory 1103, and a communication bus 1104. The processor 1101, the communication interface 1102, and the memory 1103 communicate with each other through the communication bus 1104.

The memory 1103 is configured to store a computer program.

The processor 1101 is configured to implement, when executing the computer program, the steps of the foregoing method.

The processor 1101 implements, when executing the computer program, the following steps:
step 1: obtaining a first opening shape, wherein a first preset direction corresponds to a length of the first opening shape, a second preset direction corresponds to a width of the first opening shape, and the first preset direction and the second preset direction are perpendicular to each other;
step 2: obtaining a preset spray printing dot;
step 3: obtaining a qualification ratio T according to a ratio of a total solder-paste weight Q corresponding to a total length of spray-printing line segments to a solder-paste weight Q₁ required for the first opening shape or a ratio of the total length of all the spray-printing line segments to a line length LA, wherein the spray-printing line segments are line segments finally within the first opening shape, and the qualification ratio is a weight ratio or a length ratio; and
step 4: determining a relationship among the qualification ratio T, a preset maximum qualification ratio Tₘₐₓ, and a preset minimum qualification ratio Tₘᵢₙ; and obtaining a first spray pattern if Tₘᵢₙ<T<Tₘₐₓ is satisfied; or adjusting a parameter if Tₘᵢₙ<T<Tₘₐₓ is not satisfied, and obtaining a first spray pattern if Tₘᵢₙ<T<Tₘₐₓ is satisfied after the parameter is adjusted; or performing step 2 to adjust the preset spray printing dot if Tₘᵢₙ<T<Tₘₐₓ is still not satisfied after the parameter is adjusted, and performing step 3 and step 4 again according to the adjusted preset spray printing dot until Tₘᵢₙ<T<Tₘₐₓ is satisfied, to obtain a first spray pattern.

The electronic device provided in this embodiment of the present disclosure may perform the foregoing method embodiments, and their implementation principles and technical effects are similar.

### Embodiment 5

This embodiment provides a non-transitory computer-readable storage medium, storing a computer program, the computer program, when executed by a processor, implementing the following steps:
step 1: obtaining a first opening shape, wherein a first preset direction corresponds to a length of the first opening shape, a second preset direction corresponds to a width of the first opening shape, and the first preset direction and the second preset direction are perpendicular to each other;
step 2: obtaining a preset spray printing dot;
step 3: obtaining a qualification ratio T according to a ratio of a total solder-paste weight Q corresponding to a total length of spray-printing line segments to a solder-paste weight Q₁ required for the first opening shape or a ratio of the total length of all the spray-printing line segments to a line length LA, wherein the spray-printing line segments are line segments finally within the first opening shape, and the qualification ratio is a weight ratio or a length ratio; and
step 4: determining a relationship among the qualification ratio T, a preset maximum qualification ratio Tₘₐₓ, and a preset minimum qualification ratio Tₘᵢₙ; and obtaining a first spray pattern if Tₘᵢₙ<T<Tₘₐₓ is satisfied; or adjusting a parameter if Tₘᵢₙ<T<Tₘₐₓ is not satisfied, and obtaining a first spray pattern if Tₘᵢₙ<T<Tₘₐₓ is satisfied after the parameter is adjusted; or performing step 2 to adjust the preset spray printing dot if Tₘᵢₙ<T<Tₘₐₓ is still not satisfied after the parameter is adjusted, and performing step 3 and step 4 again according to the adjusted preset spray printing dot until Tₘᵢₙ<T<Tₘₐₓ is satisfied, to obtain a first spray pattern.

The computer-readable storage medium provided in this embodiment of the present disclosure may perform the foregoing method embodiments, and their implementation principles and technical effects are similar.

A person skilled in the art should understand that the embodiments of the present disclosure may be provided as a method, an apparatus (device), or a computer program product. Therefore, the present disclosure may be in a form of hardware-only embodiments, software-only embodiments, or embodiments with a combination of software and hardware. They may be collectively referred to as “modules” or “systems” herein. Moreover, the present disclosure may use a form of a computer program product that is implemented on one or more computer-usable storage media (including but not limited to a disk memory, a CD-ROM, an optical memory, and the like) that include computer-usable program code. The computer program is stored/distributed in a proper medium and is provided as or used as a part of the hardware together with another hardware, or may also use another allocation form, such as by using the Internet or another wired or wireless telecommunication system.

In the description of the present disclosure, it should be understood that the terms such as “first” and “second” are used only for the purpose of description, and should not be understood as indicating or implying the relative importance or implicitly specifying the number of the indicated technical features. Therefore, features defining “first” and “second” may explicitly or implicitly include one or more such features. In the description of the present disclosure, “a plurality of” means two or more, unless otherwise definitely and specifically indicated.

In the description of this specification, a description of a reference term such as “an embodiment”, “some embodiments”, “an example”, “a specific example”, or “some examples” means that a specific feature, structure, material, or characteristic that is described with reference to the embodiment or the example is included in at least one embodiment or example of the present disclosure. In this specification, schematic representations of the above terms are not necessarily directed to the same embodiments or examples. Moreover, the specific features, structures, materials, or characteristics described may be combined in any one or more embodiments or examples in an appropriate manner. In addition, a person skilled in the art may combine different embodiments or examples described in this specification.

The foregoing content describes the present disclosure in detail with reference to specific exemplary embodiments, and should not be construed as restrictions on the specific implementation of the present disclosure. A person of ordinary skill in the art, to which the present disclosure belongs, may further make simple deductions or replacements without departing from the concept of the present disclosure, and such deductions or replacements should all be considered as falling within the protection scope of the present disclosure.

1. A method for generating spray patterns, comprising:
step 1: obtaining a first opening shape, wherein a first preset direction corresponds to a length of the first opening shape, a second preset direction corresponds to a width of the first opening shape, and the first preset direction and the second preset direction are perpendicular to each other;
step 2: obtaining a preset spray printing dot;
step 3: obtaining a qualification ratio T according to a ratio of a total solder-paste weight Q corresponding to a total length of spray-printing line segments to a solder-paste weight Q₁ required for the first opening shape or a ratio of the total length of all the spray-printing line segments to a line length LA, wherein the spray-printing line segments are line segments finally within the first opening shape, and the qualification ratio is a weight ratio or a length ratio; and
step 4, comprising
step 4.1, determining a relationship among the qualification ratio T, a preset maximum qualification ratio Tₘₐₓ, and a preset minimum qualification ratio Tₘᵢₙ; and
step 4.2, obtaining a first spray pattern if Tₘᵢₙ<T<Tₘₐₓ is satisfied; or
step 4.3, comprising
step 4.3.1: adjusting a parameter if Tₘᵢₙ<T<Tₘₐₓ is not satisfied, and
step 4.3.2: obtaining a first spray pattern if Tₘᵢₙ<T<Tₘₐₓ is satisfied after the parameter is adjusted; or
repeating step 2 to adjust the preset spray printing dot if Tₘᵢₙ<T<Tₘₐₓ is still not satisfied after the parameter is adjusted, and repeating step 3 and step 4 according to an adjusted preset spray printing dot until Tₘᵢₙ<T<Tₘₐₓ is satisfied, to obtain the first spray pattern.

2. The method for generating spray patterns according to claim 1, wherein step 1 comprises:
step 1.1: obtaining an initial opening shape; and
step 1.2: determining whether a length direction of the initial opening shape is parallel to the first preset direction; if so, the initial opening shape being the first opening shape; and if not, rotating the initial opening shape by an angle G so that the length direction of the initial opening shape is parallel to the first preset direction to obtain the first opening shape.

3. The method for generating spray patterns according to claim 1, wherein step 3 comprises:
step 3.1: obtaining the line length LA according to the solder-paste weight Q₁ required for the first opening shape and a linear solder-paste density q corresponding to the preset spray printing dot;
step 3.2: obtaining a line segment quantity N of the spray-printing line segments according to an area coefficient K, the line length LA, and a length L_{rect} of a minimum bounding rectangle, wherein the minimum bounding rectangle is a smallest rectangle comprising the first opening shape;
step 3.3: obtaining, according to a width W_{rect} of the minimum bounding rectangle and the line segment quantity N, the spray-printing line segments that are entirely within the first opening shape; and
step 3.4: obtaining the weight ratio according to the ratio of the total solder-paste weight Q corresponding to the total length of all the spray-printing line segments to the solder-paste weight Q₁ required for the first opening shape, or obtaining the length ratio according to the ratio of the total length of all the spray-printing line segments to the line length LA.

4. The method for generating spray patterns according to claim 3, wherein step 3.1 comprises:
step 3.11: obtaining the solder-paste weight Q₁ required for the first opening shape according to an opening volume S₁ of the first opening shape and a solder-paste density m₁; and
step 3.12: obtaining the line length LA according to a ratio of the solder-paste weight Q₁ required for the first opening shape to the linear solder-paste density q.

5. The method for generating spray patterns according to claim 3, wherein the obtaining the weight ratio according to the ratio of the total solder-paste weight Q corresponding to the total length of all the spray-printing line segments to the solder-paste weight Q₁ required for the first opening shape comprises:
obtaining the total solder-paste weight Q according to the total length of all the spray-printing line segments and the linear solder-paste density q corresponding to the preset spray printing dot; and
obtaining the weight ratio according to the ratio of the total solder-paste weight Q to the solder-paste weight Q₁ required for the first opening shape.

6. The method for generating spray patterns according to claim 3, wherein the parameter required to be adjusted comprises a length of the spray-printing line segments in an X-axis direction or a quantity of the spray-printing line segments in a Y-axis direction.

7. The method for generating spray patterns according to claim 6, wherein when in step 4.3.1, T≤Tₘᵢₙ,
step 4.3.1 comprises: increasing the quantity of the spray-printing line segments in the Y-axis direction, and performing step 3.3 again,
step 4.3.2 comprises:
if Tₘᵢₙ<T<Tₘₐₓ is satisfied after step 4.3.1, obtaining the first spray pattern;
if Tₘᵢₙ<T<Tₘₐₓ is not satisfied after step 4.3.1 and T<Tₘᵢₙ, repeatedly increasing the quantity of the spray-printing line segments in the Y-axis direction, and performing step 3.3 again in each repetition until Tₘᵢₙ<T<Tₘₐₓ is satisfied, to obtain the first spray pattern; and
if Tₘᵢₙ<T<Tₘₐₓ is not satisfied after step 4.3.1 and T≥Tₘₐₓ, shortening the length of the spray-printing line segments in the X-axis direction, performing step 3.3 again, and determining whether Tₘᵢₙ<T<Tₘₐₓ is satisfied after the length of the spray-printing line segments in the X-axis direction is shortened;
if yes, obtaining the first spray pattern; and
if not, performing step 2 to adjust the preset spray printing dot, and performing step 3 and step 4 again according to the adjusted preset spray printing dot until Tₘᵢₙ<T<Tₘₐₓ is satisfied, to obtain the first spray pattern.

8. The method for generating spray patterns according to claim 6, wherein when in step 4.3.1, T≥Tₘₐₓ,
step 4.3.1 comprises: shortening the length of the spray-printing line segments in the X-axis direction, performing step 3.3 again, and
step 4.3.2 comprises:
if Tₘᵢₙ<T<Tₘₐₓ is satisfied after step 4.3.1, obtaining the first spray pattern;
if Tₘᵢₙ<T<Tₘₐₓ is not satisfied after step 4.3.1 and T≥Tₘₐₓ, repeatedly shortening the length of the spray-printing line segment in the X-axis direction, and performing step 3.3 again in each repetition until Tₘᵢₙ<T<Tₘₐₓ is satisfied, to obtain the first spray pattern; or decreasing the quantity of the spray-printing line segments in the Y-axis direction, performing step 3.3 again, and determining whether Tₘᵢₙ<T<Tₘₐₓ is satisfied after the quantity of the spray-printing line segments in the Y-axis direction is decreased;
if yes, obtaining the first spray pattern;
if not and T≥Tₘₐₓ, repeatedly decreasing the quantity of the spray-printing line segments in the Y-axis direction, and performing step 3.3 again in each repetition until Tₘᵢₙ<T<Tₘₐₓ is satisfied, to obtain the first spray pattern; and
if not and T≤Tₘᵢₙ, increasing the quantity of the spray-printing line segments in the Y-axis direction, performing step 3.3 again, and determining whether Tₘᵢₙ<T<Tₘₐₓ is satisfied after the quantity of the spray-printing line segments in the Y-axis direction is increased;
if yes, obtaining the first spray pattern;
if not and T≤Tₘᵢₙ, repeatedly increasing the quantity of the spray-printing line segments in the Y-axis direction, and performing step 3.3 again in each repetition until Tₘᵢₙ<T<Tₘₐₓ is satisfied, to obtain the first spray pattern; and
if not and T≥Tₘₐₓ, shortening the length of the spray-printing line segments in the X-axis direction, performing step 3.3 again, and determining whether Tₘᵢₙ<T<Tₘₐₓ is satisfied after the length of the spray-printing line segments in the X-axis direction is shortened;
if yes, obtaining the first spray pattern; and
if not, performing step 2 to adjust the preset spray printing dot, and performing step 3 and step 4 again according to an adjusted preset spray printing dot until Tₘᵢₙ<T<Tₘₐₓ is satisfied, to obtain the first spray pattern.

9. The method for generating spray patterns according to claim 2, wherein after step 4, the method further comprises:
reversely rotating the first spray pattern by the angle G to obtain a second spray pattern.

10. A system for generating spray patterns, comprising:
a first obtaining module, configured to obtain a first opening shape, wherein a first preset direction corresponds to a length of the first opening shape, a second preset direction corresponds to a width of the first opening shape, and the first preset direction and the second preset direction are perpendicular to each other;
a second obtaining module, configured to obtain a preset spray printing dot;
a qualification ratio generation module, configured to obtain a qualification ratio T according to a ratio of a total solder-paste weight Q corresponding to a total length of spray-printing line segments to a solder-paste weight Q₁ required for the first opening shape or a ratio of the total length of all the spray-printing line segments to a line length LA, wherein the spray-printing line segments are line segments finally within the first opening shape, and the qualification ratio is a weight ratio or a length ratio; and
a spray pattern generation module, configured to determine a relationship among the qualification ratio T, a preset maximum qualification ratio Tₘₐₓ, and a preset minimum qualification ratio Tₘᵢₙ; and obtain a first spray pattern if Tₘᵢₙ<T<Tₘₐₓ is satisfied; or adjust a parameter if Tₘᵢₙ<T<Tₘₐₓ is not satisfied, and obtain a first spray pattern if Tₘᵢₙ<T<Tₘₐₓ is satisfied after the parameter is adjusted; or perform step 2 to adjust the preset spray printing dot if Tₘᵢₙ<T<Tₘₐₓ is still not satisfied after the parameter is adjusted, and perform step 3 and step 4 again according to an adjusted preset spray printing dot until Tₘᵢₙ<T<Tₘₐₓ is satisfied, to obtain a first spray pattern.

11. An electronic device, comprising a processor, a communication interface, a memory, and a communication bus, wherein the processor, the communication interface, and the memory communicate with each other through the communication bus;
the memory is configured to store a computer program; and
the processor is configured to implement, when executing the computer program, the steps of the method according to claim 1.

12. A storage medium, storing a computer program, the computer program, when executed by a processor, implementing the steps of the method according to claim 1.
